(19) United States
(12) Patent Application Publication
(10) Pub. No.: US 2005/0273955 A1
(43) Pub. Date: Dec. 15, 2005

(54) Bar stock degreasing machine

(76) Inventor: Thomas E. Rogus, Stephen, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/866,332

(22) Filed: Jun. 11, 2004

(51) Int. Cl. B08B 1/02

(52) U.S. Cl. 15/77; 15/88; 15/88.1

(57) ABSTRACT

A machine for washing bar stock includes an infeed to feed bars into a washing unit that has a conveyor separating each bar and discharging them to an outfeed. The cleaning is performed by brushes situated above the conveyor that sweep the lengths of the bars on the conveyor.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to a machine for degreasing metal bar stock prior to their use by fabricators or the like.

Metal fabricators often use metal bars which are shipped from the manufacturer coated with oil or grease to prevent rust or other oxidation. Even without such a protective coating, the bars also pick up dirt and grime and need to be cleaned before they may be used. The bars are often very heavy and unwieldy which creates a hazard for a person assigned to manually clean and degrease the bars. Since bar stock may be 4 feet long and up to 3 inches in diameter, the bars can be very heavy to lift free from a bundle of bars for individual cleaning. Obviously, dropping a bar could cause serious injuries.

Prior art approaches to cleaning typically involve baths such as disclosed in U.S. Pat. No. 6,440,226. Such baths need constant recycling of their fluids to prevent fouling by the cleaner and require a great deal of fluid and extra handling steps by personnel.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. § 1.56(a) exists.

### BRIEF SUMMARY OF THE INVENTION

The invention provides a bar stock degreaser that allows an entire bundle of bars to be placed on a receiving section by a fork truck. The bundle is cut open and the bars are then gently fed by gravity one at a time into the degreaser which has a plurality of brushes that wipe the rolling bars from end to end with a cleaning liquid to clean the bars. After cleaning the bars are dropped onto a staging zone where they may be removed and used.

### BRIEF DESCRIPTION OF THE DRAWINGS

A detailed description of the invention is hereafter described with specific reference being made to the drawings in which:

FIG. 1 is a side elevational view of the bar stock degreaser of the invention;

FIG. 2 is a side elevational view of the other side of the degreaser from FIG. 1;

FIG. 3 is a top view of the degreaser of FIG. 1;

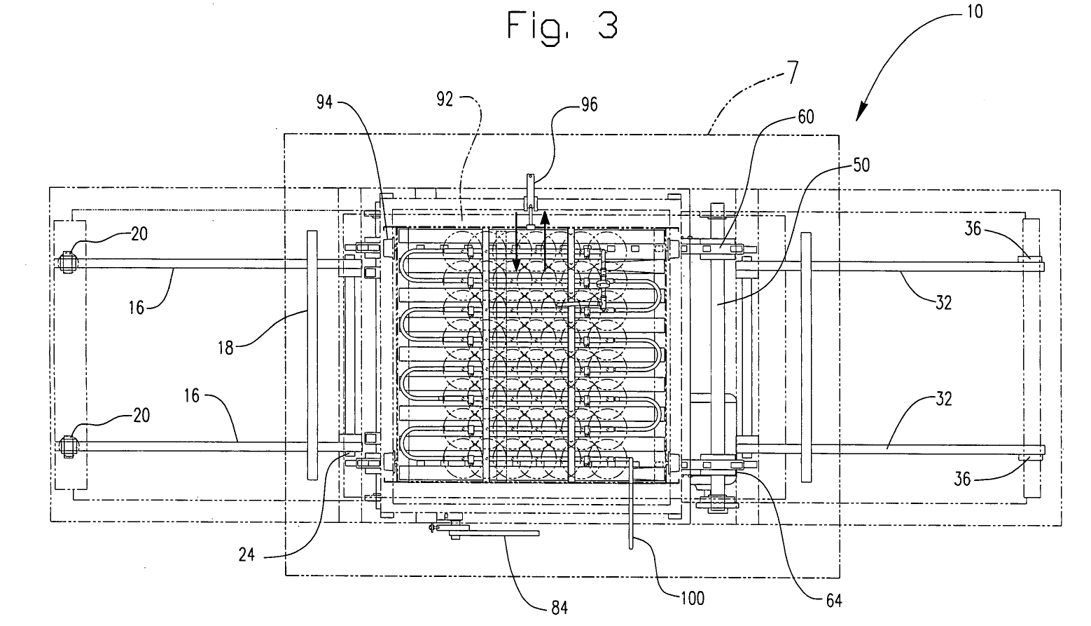

FIG. 4 is an enlarged side view of the degreaser of FIG. 1 with parts cut away;

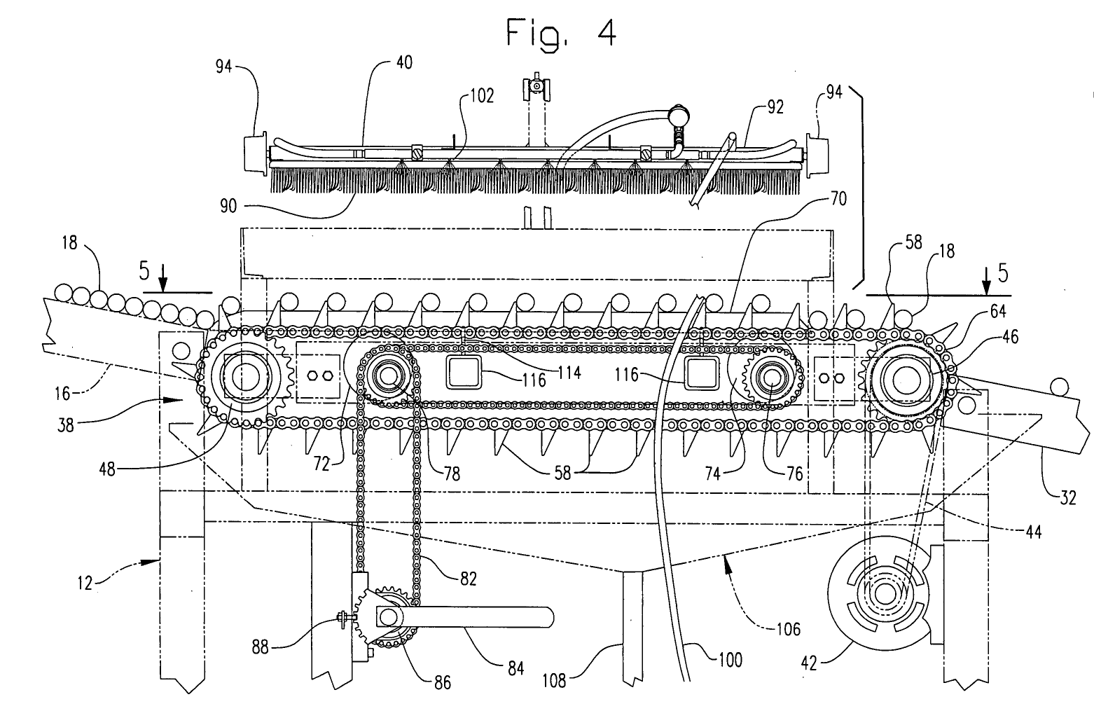

FIG. 5 is a top view of the degreaser of FIG. 3 with parts cut away;

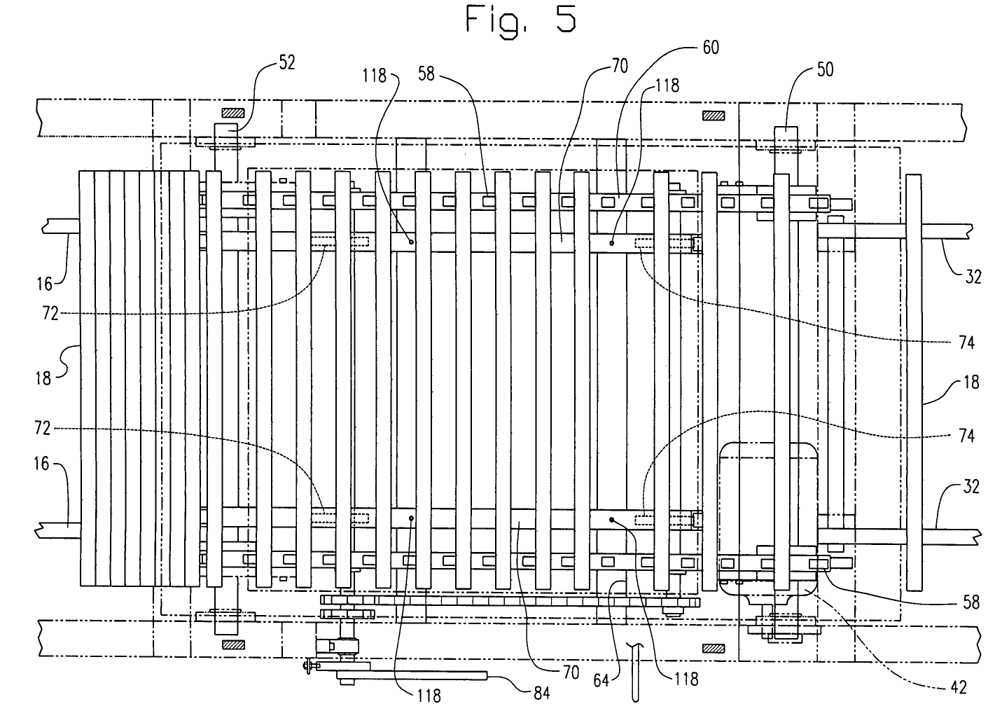

FIG. 6 is a top view of the degreaser as in FIG. 5 with fewer bars to be cleaned;

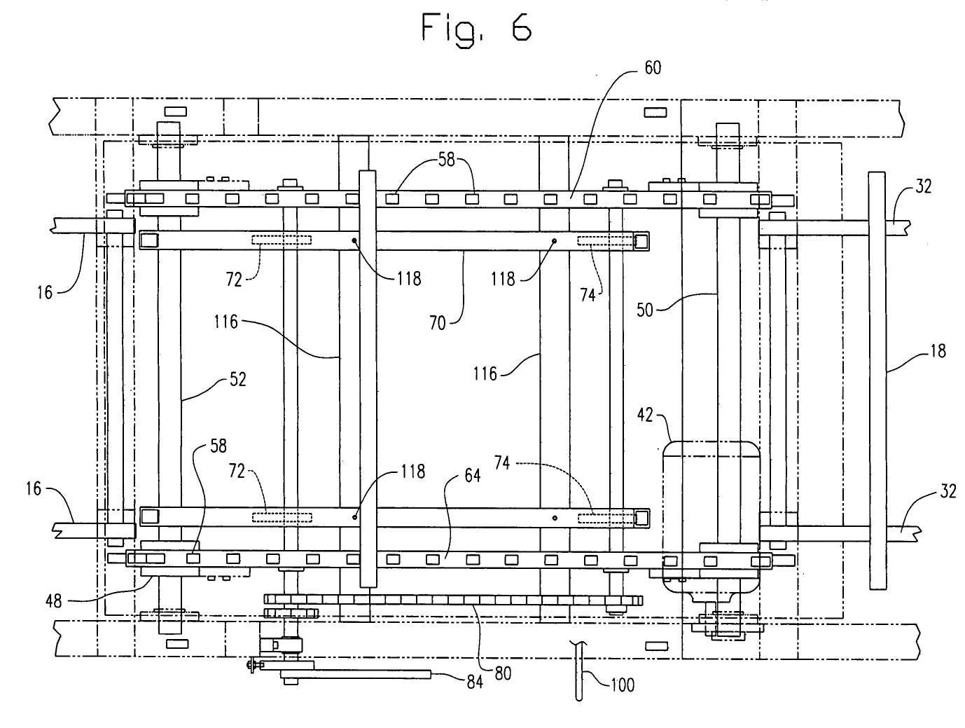

FIG. 7 is an enlarged view the degreaser of FIG. 3.

### DETAILED DESCRIPTION OF THE INVENTION

With reference to the figures, bar washing machine 10 is constructed with a washer frame 12 to support the main washer 40 and bar conveyor system. Bars 18 to be cleaned are placed on an adjustable height infeed 14 which includes a pair of separated infeed frame members 16 which hold the bars 18 to be cleaned. One end of the infeed frame members 16 is hingedly attached to washer frame 12 at hinge point 24. The other end of the infeed frame members are hingedly attached to a height adjustment mechanism 22 which allows the infeed frame members 16 to be raised or lowered to vary the gravity feed speed to the washer 40. A stop 20 may be at the ends of infeed frame 16 to prevent bars 18 from accidentally falling off.

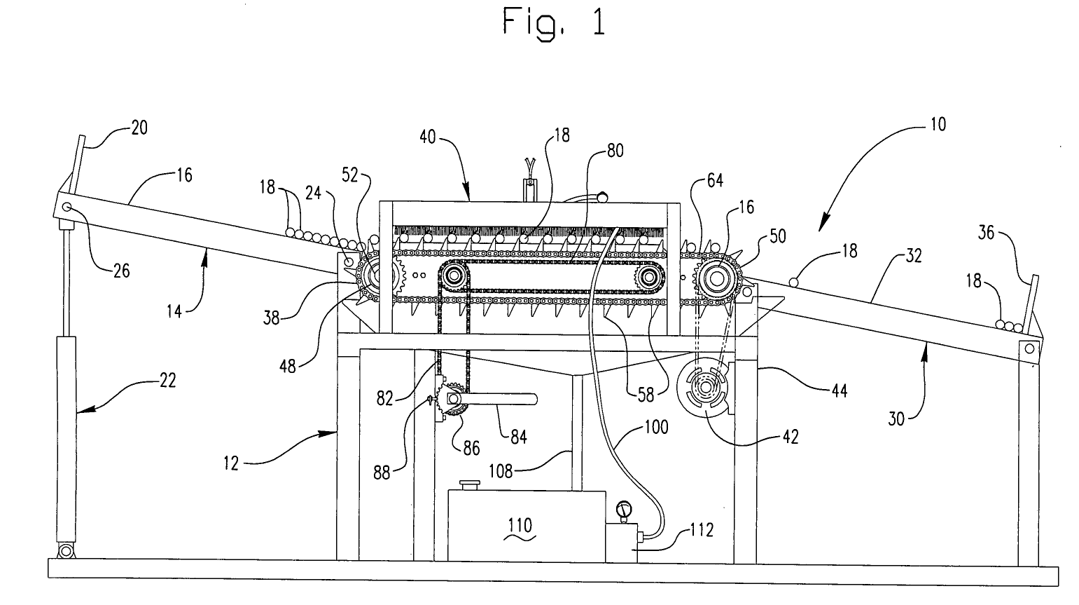

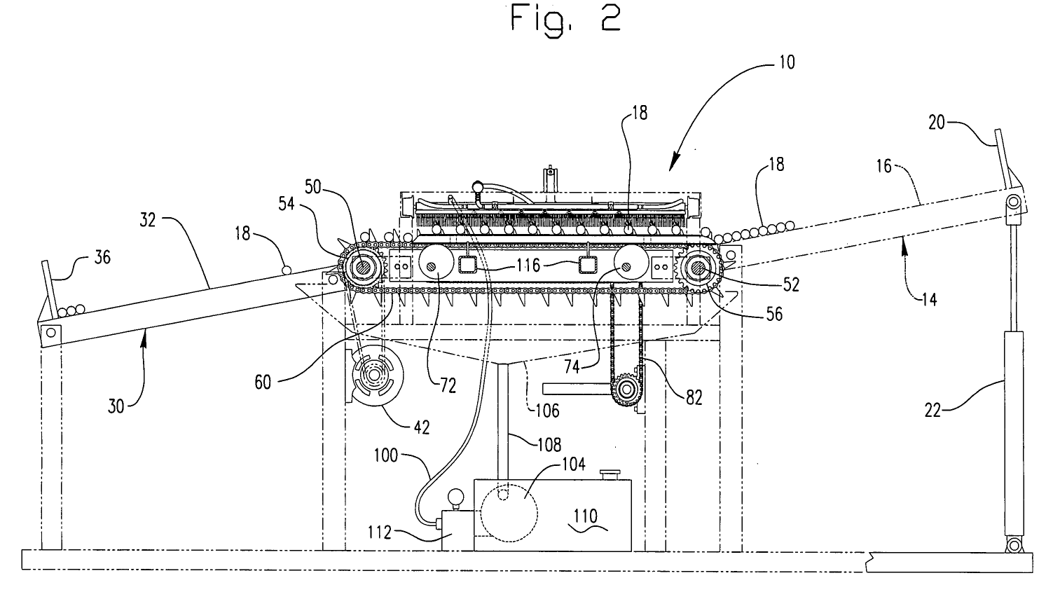

Bars 18 move from left to right in FIG. 1 from the infeed to the bar conveyor 38. The conveyor 38 is powered by motor 42 through belt 44 which drives a pulley on the main drive sprocket 46. A chain 64 connects between drive sprocket 46 and first sprocket 48. Sprockets 46 and 48 are connected to shafts 50, 52, such that like sprockets 54, 56, as seen in the back of the machine of FIG. 2, and their chain 60 move together as a unit.

Chains 48, 60 include a plurality of spaced fingers 58 to separate bar stock 18 and push each bar 18 through the machine 10. Bars 18 do not rest on chains 48, 60. Instead, bars 18 are carried on bar frame 70 which may be moved up or down by virtue of cams 72, 74 which may be rotated by movement of sprockets 76, 78 by chains 80, 82. Movement of lever 84 causes its sprocket 86 to move clockwise or counterclockwise to raise or lower bar frame 70 by the movement of cams 72, 74. Once at the height desired, the height is fixed by a pin 88 against lever 84. Bar frame 70 floats above washer platform frame 12 on pins 114 attached to frame members 116 that are secured to main platform frame 12. Openings 118 in bar frame 70 receives the pins 114 which keep the bar frame 70 aligned and allows for vertical movement.

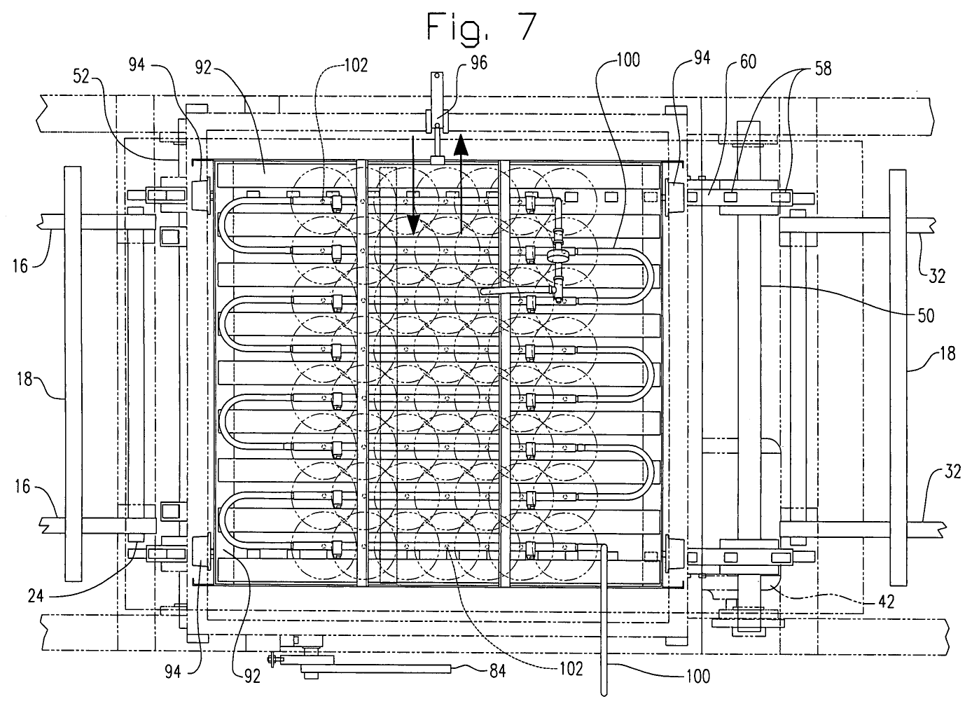

The washer 40 is suspended above the bars 18 on bar frame 70 which has a plurality of brushes 90 held to a rectangular frame 92. As best shown in FIG. 7, the frame 92 has wheels 94 which rest on frame members to allow the frame 92 to move back and forth to scrub the length of bars 18 situated underneath. The rectangular frame 92 is driven back and forth in the direction of the arrows in the Figure by a hydraulic mechanism 96.

The scrubbing action of the brushes 90 may be enhanced by supplying water, detergent, solvents or a combination to the brushes through line 100 which has openings 102 to dispense liquid to the brushes. The liquid is pumped using pump 104 from supply tank 112.

Once used, the liquid, dirt and grease passes through the device into a catch basin 106 and is funneled down through tube 108 into a waste reservoir tank 110. The waste reservoir tank 110 may be filtered and reused depending on the contaminants involved.

Bars 18 are thoroughly scrubbed from end to end by brushes 90. The brushes apply downward pressure on bars 18 which together with the left to right movement by the conveyor 38 causes the bars 18 to rotate on bar frame 70. This rotation increases the effectiveness of the scrubbing since the entire circumference of the bars 18 is presented to the brushes 90 for cleaning. The height of bar frame 70 is adjusted for the diameter of the bars 18 to be cleaned such that brushes 90 exert a downward pressure on the bars as they are pushed through the conveyor 38.

In operation, bars 18 to be cleaned are placed on the infeed frame 16 which has typically been lowered in height using adjustment mechanism 22 until it is level. The bars 18 are typically in a bundle and may be placed on the infeed by a fork truck or the like. The infeed frame free end is then raised by the hydraulic mechanism 22 to provide a gravity feed to the main washer 10. The motor 42 drives the spaced fingers which take the bars 18 through the completed wash cycle.

This completes the description of the preferred and alternate embodiments of the invention. Those skilled in the art may recognize other equivalents to the specific embodiment described herein which equivalents are intended to be encompassed by the claims attached hereto.

1. A bar washing machine comprising:
(a) a conveyor for moving bars through the washing machine; and
(b) a wash unit situated above said conveyor including a plurality of brushes that are constructed and arranged to wipe the bars lengthwise while on said conveyor.

2. The bar washing machine of claim 1 further including a gravity fed infeed station which feeds bars to be cleaned into said conveyor by gravity.

3. The bar washing machine of claim 2 further including an outfeed station which accepts cleaned bars from said conveyor and moves them by gravity away from said conveyor.

4. The bar washing machine of claim 1 wherein said conveyor includes spaced fingers to separate each bar and to push each bar through the bar washing machine.

5. The bar washing machine of claim 4 wherein said machine includes a height adjustment mechanism for raising and lowering the height of bars in the machine relative to the brushes such that the height may be adjusted to keep contact with the bars and brushes.

6. The bar washing machine of claim 2 wherein the height of said infeed station relative to said conveyor may be adjusted to change the rate of gravity feed.

7. The bar washing machine of claim 3 wherein said outfeed station includes a pair of separated rails and an end stop to stop movement of bars on said outfeed station.

8. The bar washing machine of claim 7 wherein said outfeed station rails are separated a distance to allow forks of a fork truck to be placed under said rails and lift to remove cleaned bars from the outfeed station.

9. A bar washing machine comprising:
(a) a gravity infeed station having a pair of rails that guide bars to be cleaned by gravity to a conveyor;
(a) a conveyor for moving bars through the washing machine;
(b) a wash unit situated above said conveyor including a plurality of brushes that are constructed and arranged to wipe the bars lengthwise while on said conveyor and to apply sufficient downward pressure to create enough friction to roll the bars while the fingers are pushing the bars; and
(c) an outfeed station which accepts cleaned bars from said conveyor and moves them by gravity away from said conveyor.
